(19) United States
(12) Patent Application Publication
(10) Pub. No.: US 2023/0193873 A1
(43) Pub. Date: Jun. 22, 2023

(54) ROTOR BLADE, ROTOR, AND SYSTEM HAVING ROTOR AND ROTOR BLADE

(71) Applicants: Sebastian JENSEN, Clenze (DE); Frank BUDDENHAGEN, Hamburg (DE)

(72) Inventors: Sebastian JENSEN, Clenze (DE); Frank BUDDENHAGEN, Hamburg (DE)

(21) Appl. No.: 17/799,419

(22) PCT Filed: Feb. 12, 2021
(86) PCT No.: PCT/EP2021/053485

§ 371 Date: Aug. 12, 2022

(30) Foreign Application Priority Data
Feb. 13, 2020 (EP) 20157160.1

(51) Int. Cl. F03D 3/06; F03D 9/25

(52) U.S. Cl. CPC F03D 3/062; F03D 3/061; F03D 9/25

(57) ABSTRACT

A rotor blade for a rotor having a vertical rotor shaft provides stream induced driving of the rotor in a direction of driving. The rotor blade includes streaming elements that are arranged successively and at a distance in the direction of driving, wherein each streaming element includes a front edge in the direction of driving and a rear edge in the direction of driving. The rear edge and the front edge are each formed such that, when streamed against by a wind component, it transmits a driving force to the rotor in the direction of driving. Furthermore, a rotor has a rotor blade and a system includes the rotor and an electric machine.

### TECHNICAL FIELD

The present disclosure relates to a rotor blade, a rotor having at least one rotor blade as described herein, and a system having a rotor as described herein, rotor blade and an electric machine.

### PRIOR ART

Rotors are known which comprise a rotational axis that extends substantially vertical in an installed state and through which a rotor shaft extends. One or more rotor blades are fixed to the rotor shaft, wherein the rotor blades are denoted as wing blades or rotor blades shovels as well. Each of the rotor blades provides a working surface or working area for a wind component. When the wind component is applied to the working surface, it rotates the rotor about the rotational axis, in an direction of driving that is defined by the shape of the rotor blades and that is thus predetermined.

Such a rotor having a rotor shaft that extends vertically is advantageous over rotors having a rotor shaft that extends horizontally in that a pivoting depending on the wind direction and/or an adjustment of a pitch angle of the rotor blade is not needed. Known rotors having a rotor shaft that extends vertically include, for example, a Savonius rotor, a Darrieus rotor, and an H rotor. In an H rotor, the typically a plurality of rotor blades are connected to the rotor shaft via mechanical links and extend substantially in parallel to the rotor shaft.

The rotor blades known in the art generally have a shape that—in a largely independent manner from a positioning of the rotor blade to the wind direction—when streamed against, transmit a force to the rotor shaft in the direction of driving. Yet, there is a demand for raising the efficiency of the known rotors.

### SUMMARY OF THE INVENTION

For solving the objective, a rotor blade according to the independent claim 1 is provided, for a rotor having a vertical rotor shaft. Preferred embodiments are specified in the dependent claims. Embodiments that use the rotor blade according to the independent claim 1 are a rotor according to claims 11-12 and a system according to claims 13-14.

According to an embodiment, a rotor blade for a rotor having a vertical rotor shaft and for stream induced driving of the rotor in a direction of driving comprises a plurality of streaming elements that are arranged successively and at a distance in the direction of driving, wherein each streaming element comprises a front edge in the direction of driving and a rear edge in the direction of driving, and wherein each rear edge and each front edge are at least in a main power transmission region each formed such that, when streamed against by a wind component, it transmits a driving force to the rotor in the direction of driving.

The direction of driving as used herein corresponds to the rotational direction or direction of rotation of the rotor and is predetermined or preset by the arrangement and shaping of the rotor blade or the rotor blades. The direction of driving herein also corresponds to the circumferential direction of the single elements that are arranged about the central vertically extending rotor shaft. The driving force, as used herein, is always the force that acts in the direction of driving (the rotational direction).

When mentioning the “rotor blade” herein, the description is typically carried out for a single rotor blade, but there is no exclusion of a rotor having multiple identical rotor blades or multiple rotor blades of similar type, as described herein. Typically, a rotor comprises multiple rotor blades, as described herein, for example, and without limitation, three rotor blades. Typically, the multiple rotor blades are arranged equidistantally in the circumferential direction. For example, and without limitation, three rotor blades are arranged at a mutual distance of 120° in the circumferential direction, wherein a suitable pitch is, for example, the angle of radial lines through comparable points on two adjacent rotor blades.

A streaming element, as used herein, is a part or element of a rotor blade. Particularly, a rotor blade as described herein comprises multiple streaming elements. The disclosure is, however, not to be interpreted in a manner that a (e.g., continuously formed) rotor blade forms one (single) streaming element itself and multiple rotor blades than would form a plurality of streaming elements. Rather, relating to the total circumference of a rotor, a rotor blade has a comparatively compact or dense elongation or spread, for example an elongation of less than 70°, particularly less than 60° and typically less than 50°, in the circumferential direction. Such a compact rotor blade then includes the multiple streaming elements.

A streaming element of the rotor blades typically extends substantially parallel to the rotor shaft. The streaming element can be formed continuously, particularly as one piece, in the direction parallel to the rotor shaft. Without limitation thereto, the streaming element can also be discontinuous in the direction parallel to the rotor shaft. Typically the streaming element extends along a bigger part of the length of the rotor shaft in the axial direction, for example more than 90% or more than 95% of the total length of the rotor shaft.

The main power transmission region, as used herein, is typically a region in which a wind component streaming against it transmits a bigger part of its force, for example more than 80% of the force that is theoretically possible, to the respective streaming element.

The leading edge or front edge of the streaming element has a shape that describes a dynamic stream shape of at least a part of the rotor blade. Typically, the front edge has a shape that describes the dynamic stream shape of at least a part of the rotor blade. The dynamic stream shape is described such that the front edge—in a case, when the prevailing wind at a point in time at the location of operation of the rotor which is equipped with the rotor blade has a wind component that streams against the streaming element from a direction that is more to the fore than the abeam direction of the rotor blade—transmits the driving force via a dynamic stream effect to the rotor. The dynamic stream effect by which the driving force is transmitted to the rotor is, for example, a dynamic lift effect that exerts the force in the direction of driving due to the installation orientation of the rotor blade when being streamed against. The abeam direction is the direction that from the axial center point of the rotor shaft radially intersects a center point of the streaming element. A center point of the streaming element can be defined, for example, through the mechanical or the mathematical center of gravity of the streaming element. The streaming direction is more to the fore than the abeam direction when the wind that is streaming against the respective streaming element comes from ahead when referring to the rotational direction of the rotor.

An envelope of the plurality of streaming elements describes the dynamic stream shape of the rotor blade. An envelope is typically a lateral area that forms a common surface of the outermost points of the edges of the streaming elements of a rotor blade. Normally, the envelope is formed by a straight-line connection of the outermost points on the edge of the streaming elements of one rotor blade. The envelope is typically a conceived or virtual surface that would be obtained when the outermost points on the edge of the streaming elements were covered with a flexible skin. The envelope is thus not an actual or real element. The envelope serves for a convenient description in the form of a concept of thinking.

The front edge of the streaming element describes, in the main power transmission region, a surface that is convex-curved in the direction of driving (a convex surface in the direction of driving). Similarly, the rear edge of the streaming element describes, in the main power transmission region, a surface that is concave-curved in the direction of driving (a concave surface in the direction of driving). A wind component that streams against more to the fore than abeam hits substantially the front edge and streams along the convex-curved surface such that a dynamic streaming force originates therefrom that acts in the direction of driving and that is transmitted, to the rotor, as a driving force acting in the direction of driving. A wind component that streams against more abaft than abeam hits substantially the rear edge, “entangles” at the concave-curved surface and exerts a pressing force in the direction of driving that is transmitted, to the rotor, as a driving force acting in the direction of driving.

The convex surface and the concave surface are each continuously curved. Continuously curved, as used herein, describes particularly a surface that is substantially free of sharp edges, tips and/or corners. In other words: None of the convex surface and the concave surface comprises a non-differentiable extremum, in each direction in space. In particular, each of the convex surface and the concave surface are differentiable substantially at each location (at each of their points). The conditions of this embodiment described above apply to the regions of the convex or concave surface, respectively, that are beyond their respective outer edges, that is, of course, the surfaces terminate at their outer edges where these conditions are not fulfilled any more.

The envelope outer side has substantially at each point a constant radial distance between the plurality of stream elements. The radius of the envelope outer side relating to the center point of the rotor is thus substantially the same at least at each place between the plurality of streaming elements as well as on their respective outer edges. Particularly, at least on the envelope outer side, the streaming elements do not run spirally into the radial center, but they extend substantially constant on the exterior of the rotor.

In embodiments, the rear edge of one or more streaming elements, typically all streaming elements, comprises a working surface whose surface area is greater than a planar surface that is drawn from the rotational axis in the radial direction through the rearmost points in the direction of driving the respective streaming element along a set of secant

In embodiments, the distance between the front edge and the rear edge of a plurality of the streaming elements is less than 5 cm. In other words: The material thickness (for example, a sheet thickness) of the streaming elements is less than 5 cm. Typical values for the material thickness are less than 3 cm or less than 2 cm. The streaming elements are thus thin in comparison to the overall dimension of the respective rotor blade, such that they do not form a crossways or transverse resistance, in the circumferential direction in each case. Typically, this applies to a plurality of streaming elements, preferrably for all streaming elements of the rotor blade that they constitute.

In embodiments the plurality of streaming elements comprises each a material thickness that increases from their outer and inner ends towards the center of the respective streaming element. The material thickness of the streaming elements may be such that it describes, or assists, respectively, a streamlined shape of the respective single streaming element. This may contribute to reduce swirls or vortexes of the impacting wind component that disturb the driving and/or to amplify swirls or vortexes of the impacting wind component that promote the driving.

In embodiments, the streaming elements are arranged successively in the direction of driving such that in the circumferential direction between two adjacent streaming elements a gap having a respective gap width is formed. The gap width enables an acting of the wind component between the adjacent streaming elements. Due to the possibility of the wind component acting between the adjacent streaming elements, each streaming element severally contributes to the generation and transmission of the driving force to the rotor, whereby the efficiency can be raised.

In embodiments, two adjacent streaming elements and typically all adjacent streaming elements of the same respective rotor blade comprise such a gap width and are formed such that an obstacle-free straight-aligned passage is formed into a rotor inner region. This may contribute to reduce swirls or vortexes of the impacting wind component that disturb the driving and/or to amplify swirls or vortexes of the impacting wind component that promote the driving.

In embodiments, a streaming element, typically each streaming element of the same rotor blade, comprises a force transmission discontinuation region having a direction of curvature that is opposite to that of the main power transmission region. The transition between the directions of curvature from the main power transmission region to the force transmission discontinuation region extends typically such that is differentiable in each point. Such a force transmission discontinuation region may contribute to further reduce swirls or vortexes of the impacting wind component that disturb the driving and/or to further amplify swirls or vortexes of the impacting wind component that promote the driving.

In embodiments, one or more parameters can be adapted to streaming conditions that are expected during normal operation at a certain location of installation. Alternative or additionally, the one or more parameters can be adapted to a dimension of the rotor blade, for example an elongation of the rotor blade in the direction of the rotational axis and/or an elongation of the rotor blade in the circumferential and/or the radial direction. The one or plural parameters typically include one or more of the following: The gap width between two adjacent streaming elements; the progression of different gap widths between multiple adjacent streaming elements; the radius of curvature of a streaming element; the progression of different radii of curvature of multiple streaming elements; number of streaming elements per rotor blade.

In embodiments, one or more, typically all, streaming elements, and preferably the rotor blade as a whole are substantially constituted of a metal material. The metal material is typically chosen such that it has a low corrositivity for the conditions to be expected at the installation location, that it is robust (that is, has a high expected operating life also under static and dynamic stress) and/or that it has a adequate specific mass. An example for a metal material typically used is a stainless steel material.

According to a further aspect, a rotor is provided having a rotor shaft that extends vertically and including at least one rotor blade as described herein.

In a further embodiment of the rotor, the number of rotor blades is adapted to the streaming conditions to be expected during normal operation and/or adapted to a size of the rotor blade, for example an elongation of the rotor blades in the direction of the rotational axis and/or an elongation of the rotor blades in the circumferential and/or radial direction.

According to yet a further aspect, a system is provided. The system comprises a rotor as described herein and an electric machine. The rotor shaft of the rotor is mechanically coupled to a machine shaft of the electric machine. The electric machine can typically be operated at least as a generator, is inputted a torque from the rotor shaft via its machine shaft, and outputs an electrical current to one or more generator terminals.

In a further embodiment of the system, it includes further a control unit for obtaining a rotational speed of the machine shaft and/or of the rotor shaft and for controlling the electric machine selectively in generator operation and motor operation. The control unit is configured such that it controls the electric machine in the motor operation when the obtained rotational speed falls below a predetermined threshold for a predetermined period.

The time period may, for example, be a period that corresponds to 10 seconds or less, for example 5 seconds or less. The rotational speed threshold may, for example, be a rotational speed of 10 rounds per minute or less, for example 5 rounds per minute or less. These values are to be understood in an exemplary and non-limiting manner Typically, at least one of the time period and the rotational speed threshold is chosen such that at a high likelihood the rotor will not transition to a state of static friction.

### SHORT DESCRIPTION OF THE DRAWINGS

FIG. 1 illustrates a sectional view of a rotor having rotor blades according to an embodiment, when the section is taken through the rotor along a plane perpendicular to the axial direction of the rotor.

FIG. 2 illustrates the sectional view of FIG. 1 with further explanations;

FIG. 3 illustrates a schematic diagram of a system having a rotor according to an embodiment and having a control unit;

FIG. 4 illustrates a sectional view along the lines of FIG. 1 and FIG. 2, of a rotor having rotor blades according to an embodiment;

FIG. 5 illustrates a streaming element having a main power transmission region; and

FIG. 6 illustrates a streaming element having a main power transmission region and a force transmission discontinuation region.

### DESCRIPTION OF EMBODIMENT(S)

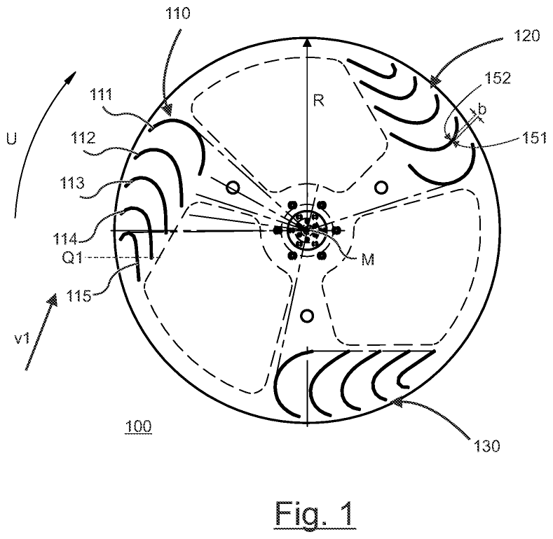

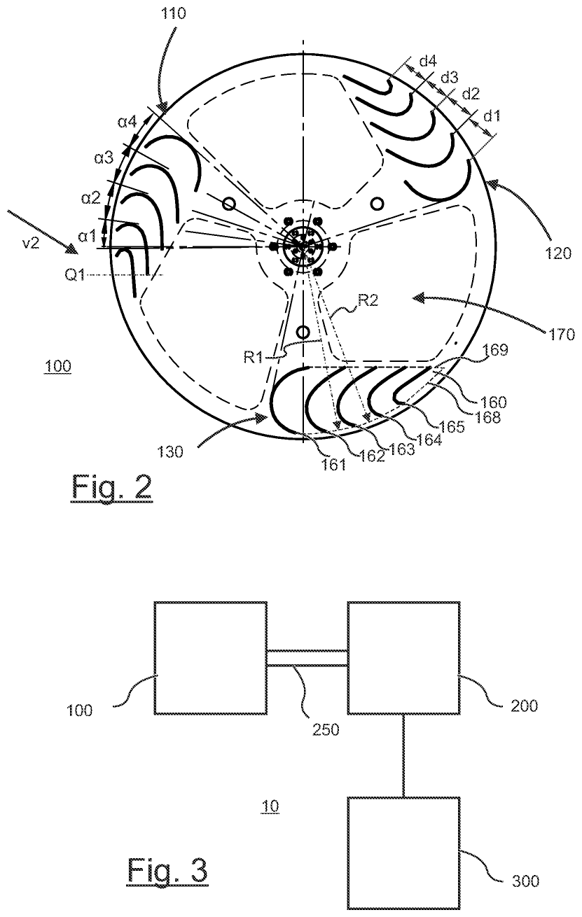

FIG. 1 and FIG. 2 are a sectional view through a rotor 100 along a plane that extends perpendicularly to the direction of a rotor shaft M of the rotor 100. The embodiment shown in FIG. 1 and FIG. 2 is the same, and for reasons of clarity, FIG. 1 and FIG. 2 differ only in the labelling provided for explanation and in the reference signs. The following description thus refers at the same time to FIG. 1 and FIG. 2.

The rotor shaft M of the rotor 100 defines, at the same time, the direction of the rotational axis, i.e. the axial direction. Fastenings, for example struts (not illustrated), extend in the radial direction R, wherein a first rotor blade 110, a second rotor blade 120 and a third rotor blade 130, respectively, or their respective elements, are fixed, as described further below. It is noted that the number of rotor blades is not limited to three, and may be one, two, four, or more than four. Also, as shown in the embodiment according to FIG. 1, the rotor blades 110, 120, 130 are configured to be of a uniform or similar type. Even though the further description will carry on with this assumption, the configuration of multiple rotor blades 110, 120, 130 is not limited to them being uniform. When reference is made to “the rotor blade 110, 120, 130” in the following, this includes the configuration respectively described of one, multiple or all rotor blades 110, 120, 130.

The rotor 100 rotates by the arrangement and configuration of the rotor blades 110, 120, 130 always in the rotational direction which is shown in FIG. 1 by an arrow U of the circumferential direction. This rotational direction is the direction of driving and is thus fixed.

The rotor blade 110, 120, 130 comprises a plurality of streaming elements 111, 112, 113, 114, 115. The number of streaming elements per rotor blade 110, 120, 130 is not limited to five, and less or more than five streaming elements may be provided. The multiple streaming elements 111, 112, 113, 114, 115 of a rotor blade 110, 120, 130 are arranged at a distance to each other in the circumferential direction U, for example at an angular distance α4 between the first or frontmost streaming element 111 and the second streaming element 112 in the rotational direction, an angular distance α3 between the second streaming element 112 and the third streaming element 113, an angular distance α2 between the third streaming element 113 and the fourth streaming element 114, and an angular distance α1 between the fourth streaming element 114 and the fifth streaming element 115. Without limitation and as an example only, for example, α1=8°, α2=11°, α3=11°, and α4=13° applies.

An abeam direction Q1 is exemplarily shown for the fifth streaming element 115. The abeam direction Q1 is the direction that, from the axial center point of the rotor shaft M, radially intersects a center point of the streaming element 115 (that is, in the direction R). An abeam direction can thus be defined for each streaming element 111, 112, 113, 114, 115.

The streaming elements 111, 112, 113, 114, 115 are each curved such that they have a front edge, or leading edge, 151 and a rear edge, or trailing edge, 152 in the direction of driving. In the embodiment shown, the streaming elements have a thin material thickness; therefore, the front edge 151 and the rear edge 152 are each spaced apart at a minute distance b that is defined by the material thickness. For example, b<5 cm applies.

In the embodiment, furthermore, the streaming elements 111, 112, 113, 114, 115 are arranged such that elements adjacent to each other are spaced apart from each other at a distance of a gap d1, d2, d3, d4.

According to the embodiment, the outer points 161, 162, 163, 164, 165 (and the respectively opposed outer points in the direction of the rotor shaft M) describe, in the sectional plane, a dynamic stream shape or a streamlined shaped 160 that effects an advancing or propulsion in the direction of driving. The streamlined shape 160 is a (conceptual) envelope that would be obtained if the outer points 161, 162, 163, 164, 165 were covered by an elastic skin such that an envelope outer side 168 is obtained, and the elastic skin were continued on the side facing a rotor inner region 170 such that an envelope inner side 169 is obtained. It is noted that the envelope 160 of the envelope outer side 168 and the envelope inner side 169 is not a real element but rather serves for a simplified description in the form of a concept of thinking.

The envelope outer side 168, between the plurality of stream elements 111, 112, 113, 114, 115, has substantially at each point a constant radial distance R1, R2. The radius of the envelope outer side 168 relating to the center point M of the rotor 100 is thus substantially the same at least at each place between the plurality of streaming elements 111, 112, 113, 114, 115 as well as on their respective outer points 161, 162, 163, 164, 165. Particularly, at least on the envelope outer side, the streaming elements 111, 112, 113, 114, 115 do not run spirally towards the center point M of the rotor 100, but they extend substantially constant on the exterior of the rotor.

The streaming elements 111, 112, 113, 114, 115 effect, by their shaping, their spacing apart or the gaps inbetween, respectively, that the rear edge 152 and the front edge 151 are each shaped such that when streamed against by a wind component v1, v2, they transmit a driving force to the rotor 100 that acts in the direction of driving.

For example, FIG. 1 shows a wind component v1 that impacts more abaft than the abeam direction Q1 onto the streaming element 115. At the same time, the wind component v1 also impacts more abaft than abeam onto the further streaming elements 111, 112, 113, 114, 115 belonging to the rotor blade 110. By the spacing apart of the streaming elements 111, 112, 113, 114, 115, the wind component v1 streaming onto the rotor blade 110 can act, through the gaps, on the respective rear edges 152 and push the rotor 100 in the direction of driving.

In the example in FIG. 2, a wind component v2 is shown that impacts more to the fore than the abeam direction Q1 onto the streaming element 115. At the same time, the wind component v2 also impacts more to the fore than abeam onto the further streaming elements 111, 112, 113, 114, 115 belonging to the rotor blade 110. By the spacing apart of the streaming elements 111, 112, 113, 114, 115, the wind component v2 streaming onto the rotor blade 110 can act, through the gaps, on the respective front edges 151 and, by the dynamic streaming effect, pull the rotor 100 in the direction of driving.

At the same time, in the example in FIG. 2, the wind component v2 also acts onto the streaming elements as a whole that form the dynamic stream shape 160. Thereby, the efficiency can be further improved.

FIG. 3 shows a schematic diagram of a system 10 having a rotor 100, an electric machine 200 and a control unit 300. The rotor shaft M is connected, via a connection shaft 250, with a machine shaft (not shown) of the electric machine 200. The connection shaft 250 may also be formed by one of the rotor shaft M and the machine shaft. Furthermore, a control unit is signally connected with the electric machine 200 and configured such that it acquires the rotational speed of the connection shaft 250, the machine shaft and/or the rotor shaft M and controls the electric machine 200 selectively in generator operation and motor operation. When the acquired rotational speed exceeds a predetermined threshold for a predetermined period, the control unit 300 controls the electric machine 200 in the motor operation.

FIG. 4 illustrates a sectional view along the lines of FIG. 1 and FIG. 2, of a rotor 100 having rotor blades 110, 120, 130 according to the embodiment. The explanations above that have been given in connection with FIGS. 1-3 also apply to FIG. 4, and repeated explanations are omitted here. As apparent from FIG. 4, the streaming elements are formed and spaced apart such that there is an obstacle-free passage along a straight line 175 into the rotor inner region 170. In FIG. 4, this is exemplary shown for the streaming elements 112, 113 of the rotor blade 130; however, this concept is applicable to all streaming elements of all rotor blades. This may contribute to an advantageous utilization of possible swirls or vortexes of the impacting wind component.

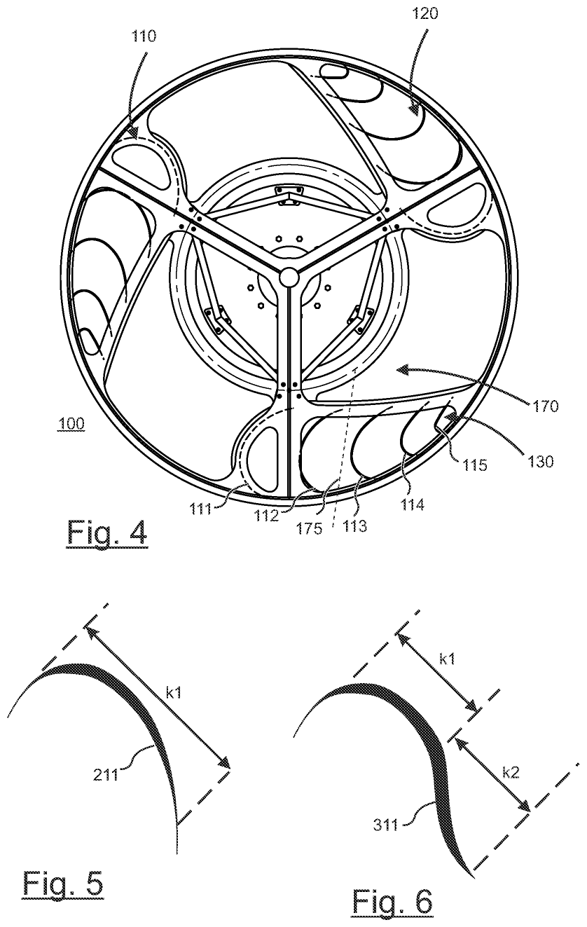

FIG. 5 illustrates a streaming element 211 having a main power transmission region k1 in which an impacting wind component transmits a greater part of its force, for example more than 80%, of the force that is theoretically possible, to the respective streaming element 211. The material thickness of the streaming element 211 increases from the outer points thereof towards the center continuously or steadily, such that substantially a streamlined shape is obtained.

FIG. 6 illustrates a streaming element 311 having a main power transmission region k1 and a force transmission discontinuation region k2. The transition between the directions of curvature from the main power transmission region k1 to the force transmission discontinuation region k2 extends typically such that is differentiable in each point. Such a force transmission discontinuation region k2 may contribute to further reduce swirls or vortexes of the impacting wind component that disturb the driving and/or to further amplify swirls or vortexes of the impacting wind component that promote the driving.

1-14. (canceled)

15: A rotor (100) having a vertical rotor shaft (M) and multiple rotor blades (110, 120, 130) that are arranged equidistantly in the circumferential direction and are of a uniform type,
wherein each rotor blade (110, 120, 130) comprises a plurality of streaming elements (111, 112, 113, 114, 115) that are arranged successively and at a distance in the direction of driving (U), wherein each streaming element (111, 112, 113, 114, 115) comprises a front edge (151) in the direction of driving and a rear edge (152) in the direction of driving (152), and wherein each rear edge (152) and each front edge (151)—at least in a main power transmission region (k1)—are each formed such that, when streamed against by a wind component (v1, v2), it transmits a driving force to the rotor (100) in the direction of driving (U),
wherein each front edge (151) has a shape that describes a dynamic stream shape of at least a part of the rotor blade, such that the front edge, when the wind component streams against from a direction that is more to the fore than the abeam direction of the rotor blade, transmits the driving force via a dynamic stream effect, typically dynamic lift effect, to the rotor (100), wherein an envelope (160) of the plurality of stream elements (111, 112, 113, 114, 115) having an envelope outer side (168) and an envelope inner side (169) describes the dynamic stream shape of the rotor blade (110, 120, 130),
wherein each front edge (151) describes a convex surface in the direction of driving in the main power transmission region (k1) and the rear edge (152) describes a concave surface in the direction of driving in the main power transmission region (k1), wherein the concave surface of the front edge (151) and the convex surface of the rear edge (152) each are continuously curved such that they substantially describe differentiable surfaces at each location,
wherein the envelope outer side (168), between the plurality of streaming elements (111, 112, 113, 114, 115), has at each point a constant radial distance (R1, R2), and
wherein all rotor blades (110, 120, 130) of the rotor (100) are configured to be of a uniform type.

16: The rotor (100) according to claim 15, wherein all streaming elements (111, 112, 113, 114, 115) of each rotor blade (110, 120, 130) extend, on the envelope outer side (168), with a constant radial distance along the exterior of the rotor.

17: The rotor (100) according to claim 15, wherein the rear edge (152) of each streaming element (111, 112, 113, 114, 115) of each rotor blade (110, 120, 130) comprises a working surface for the wind component (v1) whose surface area is greater than a planar surface through the streaming element (111, 112, 113, 114, 115) in the radial direction.

18: The rotor (100) according to claim 15, wherein the plurality of streaming elements (111, 112, 113, 114, 115) of each rotor blade (110, 120, 130) each comprise a material thickness that rises from the outer and inner ends to the center of the respective streaming element (111, 112, 113, 114, 115).

19: The rotor (100) according to claim 15, wherein the streaming elements (111, 112, 113, 114, 115) of each rotor blade (110, 120, 130) are arranged successively in the direction of driving such that in the circumferential direction between two adjacent streaming elements (111, 112, 113, 114, 115) of a same respective rotor blade (110, 120, 130) a gap having a respective gap width (d1, d2, d3, d4), is formed, wherein the gap width enables an acting of the wind component (v1, v2) between the adjacent streaming elements.

20: The rotor (100) according to claim 19, wherein all adjacent streaming elements (111, 112, 113, 114, 115), of the same respective rotor blade (110, 120, 130) are shaped and have a gap width (d1, d2, d3, d4) such that an obstacle-free straight-aligned passage (175) is formed into a rotor inner region (170).

21: The rotor (100) according to claim 15, wherein all streaming elements (111, 112, 113, 114, 115) of the same rotor blade (110, 120, 130) further comprise a force transmission discontinuation region (k2) having a direction of curvature opposite to the main power transmission region (k1), wherein a transition of the directions of curvature from the main power transmission region (k1) to the force transmission discontinuation region (k2) typically extends, in each point, in a differentiable manner.

22: The rotor (100) according to claim 15, wherein at least one of the following group is adapted to the streaming conditions to be expected during normal operation and/or adapted to a size of the rotor blade: Gap width between two adjacent streaming elements; progression of different gap widths between multiple adjacent streaming elements; progression of different radii of curvature of multiple streaming elements; number of streaming elements per rotor blade.

23: The rotor (100) according to claim 15, wherein the streaming elements (111, 112, 113, 114, 115) of each rotor blade (110, 120, 130) are formed of a metal material.

24: The rotor (100) according claim 15, wherein the number of rotor blades (110, 120, 130) is adapted to the streaming conditions to be expected during normal operation and/or adapted to a size of the rotor blade.

25: A system (10) having a rotor (100) according to claim 15 and an electric machine (200), wherein the rotor shaft (M) of the rotor is mechanically coupled to a machine shaft of the electric machine (200).

26: The system (10) according to claim 25, further comprising a control unit (300) for obtaining a rotational speed of the machine shaft and/or of the rotor shaft and for controlling the electric machine selectively in generator operation and motor operation, wherein the control unit is configured such that it controls the electric machine (200) in the motor operation when the obtained rotational speed falls below a predetermined threshold for a predetermined period.
